(19) United States
(12) Patent Application Publication
(10) Pub. No.: US 2021/0070064 A1
(43) Pub. Date: Mar. 11, 2021

(54) PROCESS FOR DEPOSITING MULTIPLE FLUID LAYERS ON VARIOUS SUBSTRATES

(71) Applicant: Polymeric Ireland Limited, Dublin (IE)

(72) Inventor: Deverakonda Sarma, Kansas City, MO (US)

(21) Appl. No.: 17/013,589

(22) Filed: Sep. 5, 2020

Related U.S. Application Data
(60) Provisional application No. 62/896,168, filed on Sep. 5, 2019.

(51) Int. Cl. B41J 3/407; B41J 11/00; B41M 5/50

(52) U.S. Cl. CPC B41J 3/4078; B41M 5/502; B41J 11/002

(57) ABSTRACT

Provided herein are methods for printing an image on a substrate using various methods of deposition in a single process. The methods may comprise a base layer application step wherein a base layer is applied to a portion of the substrate using a valve jet, or an inkjet printhead and a graphical application step wherein one or more ink layers are applied to a portion of the substrate (e.g., using an inkjet or a valve jet). Advantageously, the base layer may be applied only to substantially the same portion of the substrate as the one or more ink layers. The methods may further comprise a top coating step wherein a topcoat is applied to the printed portion of the substrate using a valve jet or an inkjet printhead.

### CROSS-REFERENCE TO RELATED APPLICATION

This Application claims the priority benefit of U.S. Provisional Patent Application Ser. No. 62/896,168, filed on Sep. 5, 2019, entitled “Process for Depositing Multiple Fluid Layers on Various Substrates,” currently pending, the entire disclosure of which is incorporated herein by reference.

### BACKGROUND

Digital printing, and in particular inkjet printing, is a well-known method of applying a fluid to a substrate, and is used in a variety of manufacturing processes. A key advantage of inkjet printing is the ability to print variable information, graphics, and designs onto different substrates. Unfortunately, inkjet printing is limited in the thickness of the print layer that can be created, due principally to the drop volume (typically from 1-80 picoliters (pL)) and the requirement that the fluid be amenable to jetting through a relatively small orifice (typically 10-50 microns in diameter). The fluid must have a relatively low viscosity in order to jet through the nozzle consistently, and multiple passes must often be made to provide a print layer having the proper thickness. As a result, inkjet printing is relatively slow and unreliable when a thick layer is required. Furthermore, there are often restrictions on the fluids that can be used to jet through an inkjet printhead, due to material compatibility or rheological issues.

Currently known printing methods often involve the application of a base layer or pretreatment, for example using a spray valve, to all or a significant portion of the substrate, including areas where no image is to be printed. These known techniques can result in several disadvantages, as the base layer can cause discoloration, staining and/or other performance degradation of the substrate if the applied to areas are not subsequently covered by an ink layer. Additionally, more pretreatment is applied than is necessary thereby resulting in waste and inefficiency.

There is a need in the art for an improved process that can deposit multiple fluid layers of varying thickness at a lower cost, greater efficiency, and with higher reliability than conventional prior art processes.

### SUMMARY

Provided herein, in accordance with one embodiment of the present invention, is a method for printing an image on a substrate comprising a base layer application step wherein a base layer is applied to a portion of the substrate using a valve jet or a spray valve, and a graphical application step wherein one or more ink layers are applied to a portion of the substrate (e.g., using an inkjet or a valve jet). In a preferred embodiment, the base layer is applied to substantially the same portion of the substrate as the one or more ink layers. The method may further comprise a top coating step wherein a topcoat is applied to the printed portion of the substrate using a valve jet or a spray valve. The topcoat may help protect the printed image and, as a result, improve print performance such as washfastness, light fastness, and other degradation issues.

Also provided herein is a pretreatment composition comprising one or more components, including but not limited to one or more polymer resins, coalescing agents and other additives such as defoamers, wetting agents, an adhesion promoter, and crosslinking compounds. In preferred embodiments, the pretreatment composition does not comprise any plasticizers.

Also provided herein are printed textiles prepared according to the methods described herein.

These and other aspects of the present disclosure are described in further detail below.

### DESCRIPTION OF THE FIGURES

FIG. 1 illustrates the advantages of the presently disclosed methods (right) relative to prior art methods (left). Prior art techniques utilize a spray valve to apply a base layer to all or a significant portion of the substrate, including areas where no image is to be printed. The present method, using a valve jet or an inkjet printhead, allows for the base layer to be applied only to selected portions of the fabric (e.g., those portions where a graphical image will subsequently be applied).

FIG. 2 provides a cross-sectional view of layers applied to a substrate using prior art techniques (left) and the presently disclosed methods (right). As shown, the presently disclosed methods allow for the base layer (or “pre-coating”) to be selectively applied to those portions of the substrate where a graphical image will subsequently be printed.

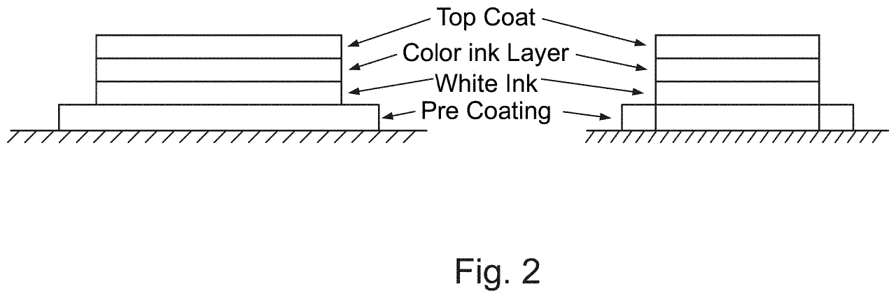

FIG. 3 is a flow chart illustrating the operations of a method for applying multiple layers on a substrate in accordance with one embodiment of the present invention.

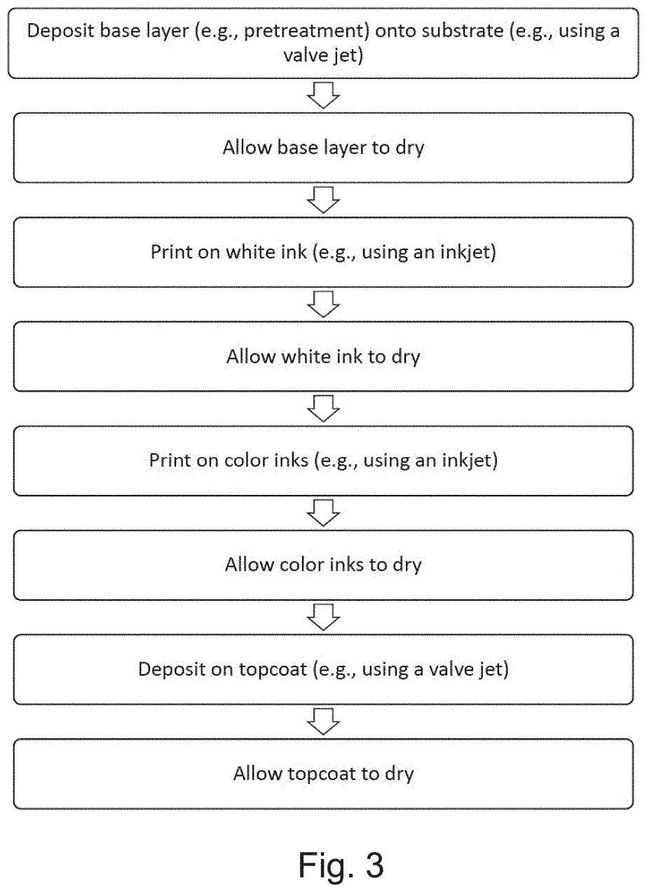

FIG. 4 is a schematic sectional diagram of a thin film solar cell manufactured in accordance with one embodiment of the present invention.

### DETAILED DESCRIPTION

Provided herein are methods for depositing or otherwise applying multiple fluid layers for use in connection with micro or nano-fabrication on various substrates, such as metals, textiles or plastics.

A wide variety of technologies, from printing graphics on textiles to manufacturing solar cells, involve the application of multiple fluid layers to a substrate. In many applications, different layers need to be deposited in different thicknesses to provide the desired functional properties. One solution to this problem, in accordance with one embodiment of the present invention, is to use multiple deposition techniques (e.g., valve jet deposition, inkjet printing, spray coating, and the like) within a single production process, in order to maximize cost effectiveness while providing the required functional properties. The deposition techniques employed may depend in part on the properties of the fluids to be deposited, but at the same time must work together in order meet the fabrication criteria.

### Method of Application

For example, provided herein is a method for printing an image onto a substrate. In one embodiment, the method comprises printing or applying a pretreatment or base layer using a valve jet or an inkjet printhead. In some embodiments, the method further comprises printing a top layer using a valve jet. Other layers may be printed digitally, for example using inkjet printing.

It will be appreciated that the methods provided herein may be adapted for various applications. The entire disclosure of U.S. Patent Application No. 62/881,092 filed on Jul. 31, 2019 to Pramudi Abeydeera and Deverakonda Sarma, entitled “Methods of Preconditioning Fabric Prior to Inkjet Printing,” is incorporated herein by reference.

Application of a Base Layer

The method may comprise a base layer application step wherein a base layer is applied to the substrate using a valve jet. For example, the base layer may be applied to the substrate using a valve jet or inkjet printhead having a diameter of at least about 30 microns in one embodiment, a diameter of at least about 50 microns in another embodiment, or a diameter of at least about 30-400 microns in a further embodiment. The relatively larger nozzle size of the valve jet produces a larger drop volume (typically from 50-350 pL) and can therefore result in a thicker layer being applied to the substrate in a more efficient manner. Many conventional materials (like resins with higher molecular weight, low and high pH, etc.) can be used to jet through a valve jet in order to provide various functional properties.

In one embodiment, the base layer application step comprises applying a pretreatment composition to the substrate. Preferred pretreatment compositions are described in further detail below.

In preferred embodiments, the base layer is applied to only a portion of the substrate. For example, the base layer may be applied generally to only the portion of the substrate where one or more additional layers are desired to be printed (e.g., where a graphical image is desired to be printed).

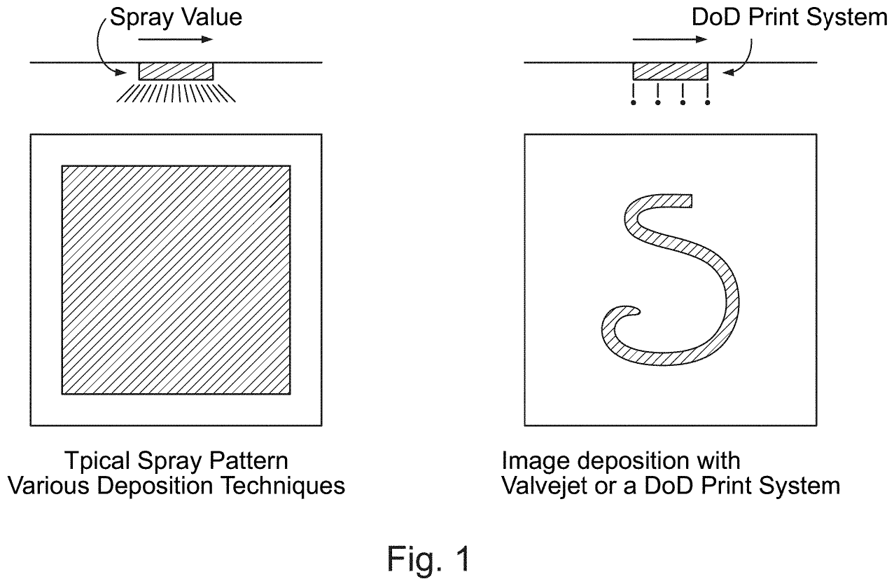

As shown in FIG. 1, prior art techniques (e.g., using a spray valve) involve application of the base layer to all or a significant portion of the substrate, including areas where no image is to be printed. These prior art techniques result in several disadvantages, as the base layer can cause discoloration or other performance degradation of the substrate if applied to areas not subsequently covered by an ink layer. The present method (e.g., using a valve jet) allows for the base layer to be applied only to the select portion of the fabric where an ink layer will subsequently be applied, and thereby overcomes the disadvantages of the prior art.

The base layer application step may further comprise drying the substrate, following application of the base layer, so as to remove moisture from the base layer.

Application of Ink Layers

The method may further comprise one or more steps wherein one or more ink layers are applied to the substrate. As a non-limiting example, the method may comprise a step wherein a white ink layer is applied to the substrate, followed by a step wherein one or more colored ink layers are applied to the substrate.

The one or more ink layers may be applied to the substrate using an inkjet, a valve jet, other suitable techniques, or a combination thereof. In one preferred embodiment, the one or more ink layers are applied to the substrate using an inkjet. In preferred embodiments, the one or more ink layers are applied only to the portion of the substrate wherein a base layer has been previously applied, as generally described above.

Once the one or more layers have been applied, the inks may be dried and/or the substrate may be cured at an elevated temperature. In one embodiment, the white ink may be allowed to dry prior to the application of the color inks, and the color inks may be allowed to dry prior to the application of a topcoat.

Application of a Topcoat

The method may comprise a top coating application step wherein a topcoat is applied to the substrate using a valve jet or an inkjet printhead. For example, the topcoat may be applied to the substrate using a valve jet or inkjet printhead having a diameter of at least about 30 microns in one embodiment, a diameter of at least about 50 microns in another embodiment, or a diameter of at least about 30-400 microns in a further embodiment.

In preferred embodiments, the topcoat is applied to only a portion of the substrate. For example, the topcoat may be applied to only the portion of the substrate where one or more additional layers are desired to be printed (e.g., where a graphical image is desired to be printed).

Prior art techniques (e.g., using a spray valve) involve application of the topcoat to all or a significant portion of the substrate, including areas where no image has been printed. These prior art techniques result in several disadvantages, as the topcoat can cause discoloration or other performance degradation of the substrate if applied to areas not previously covered by an ink layer. The present method (e.g., using a valve jet) allows for the topcoat to be applied generally only to the select portion of the fabric where an ink layer has previously been applied, and thereby overcomes the disadvantages of the prior art.

The topcoat application step may further comprise drying the substrate, following application of the topcoat, so as to remove moisture from the coated substrate.

### Pretreatment Composition

As described above, the methods provided herein may comprise a base layer application step wherein a pretreatment composition is applied to a substrate.

The pretreatment composition may comprise one or more components, including but not limited to one or more polymer resins, coalescing agents and other additives such as defoamers, wetting agents, adhesion promoters, and crosslinking compounds. In preferred embodiments, the pretreatment composition does not comprise any plasticizers.

For example, the pretreatment composition may comprise a water-dispersible polymer resin component comprising one or more water-dispersible polymer resins. Non-limiting examples of water-dispersible polymer resins include acrylic, latex emulsions, and polyurethane. Preferred water-dispersible polymer resins can include heat curable, acrylic latex emulsion with low glass transition temperature and that are compatible with salt and heat. The pretreatment composition may comprise the water-dispersible polymer resin component in an amount of from about 5% to about 40% by weight of the composition, and more preferably from about 10% to about 30% by weight of the composition.

The pretreatment composition may further comprise a coalescing solvent component comprising one or more coalescing solvents. Non-limiting examples of coalescing solvents include Ethylene Glycol n-Butyl Ether, Propylene Glycol n-Butyl Ether, Dipropylene Glycol n-Propyl Ether, Propylene Glycol Phenyl Ether, Dipropylene Glycol n-Butyl Ether and Texanol. Preferred coalescing solvents can include Dipropylene Glycol n-Butyl Ether and Texanol. The pretreatment composition may comprise the coalescing solvent component in an amount of from about 0% to about 5% by weight the composition, and more preferably from about 0% to about 2% by weight of the composition.

The pretreatment composition is preferably an aqueous composition. For example, the pretreatment composition may comprise water in an amount of from about 40% to about 90% by weight of the composition, and more preferably from about 50% to about 70% by weight of the composition.

The pretreatment composition may further comprise one or more additional additives. Non-limiting examples of additional additives include defoamers, wetting agents, adhesion promoters, and softening agents. The pretreatment composition may comprise the one or more additional additives in an amount of from 0% to about 10% by weight in one embodiment, 0% to about 8% by weight in another embodiment, and more preferably from about 0% to about 6% by weight, for example, from about 2% to about 4% by weight.

### Printed Textile

Also provided herein is a treated textile material having a quantity of the pretreatment composition described herein applied thereto. For example, the treated textile material may comprise a quantity of the pretreatment composition applied to at least an image-receiving area thereof. The treated textile material may further have an image applied to the image-receiving area, for example using water-based pigment inks.

Other objects and features will be in part apparent and in part pointed out hereinafter.

### EXAMPLES

The following non-limiting examples are provided to further illustrate the present disclosure.

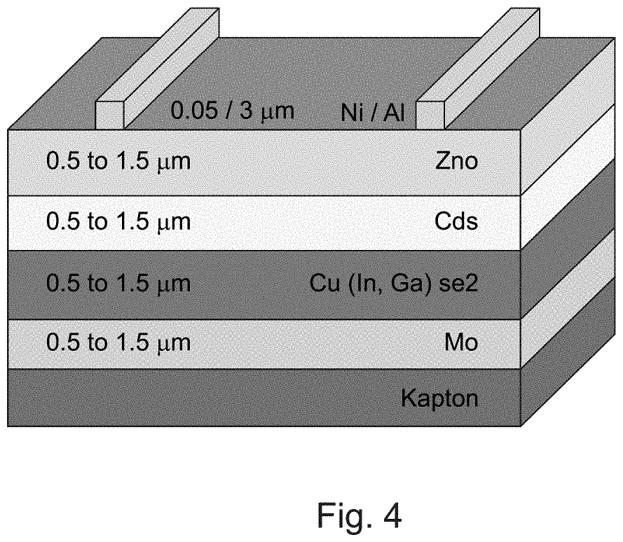

### Example 1—Thin Film Solar Cell Manufacturing Process (See FIG. 4)

Thin film solar cells contain multiple thin film layers of photovoltaic materials and are also known as thin film photovoltaic cells. The thicknesses of thin film layers are very thin (0.5-100 microns) as compared to traditional solar cells. Materials of various compositions will be deposited on different substrates like glass or polyamide. Current process steps included various technologies like spin coating, spray coating, screen printing, etc., that can take place at various locations. The same manufacturing can be done by printing layers of from about 0.5 microns to about 5 microns using a single printer with a combination of an inkjet and a valve jet in order to process quickly and with lower cost.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A method of printing an image on a substrate, the method comprising:
a base layer application step wherein a base layer is applied to the substrate using a valve jet or an inkjet printhead; and
a graphical application step wherein one or more ink layers are applied to a portion of the substrate.

2. The method of claim 1 wherein the base layer is applied to the substrate using a valve jet or an inkjet printhead having a diameter of at least about 30 microns.

3. The method of claim 1 wherein the base layer is applied to only a portion of the substrate.

4. The method of claim 3 wherein the base layer is applied to substantially the same portion of the substrate as the one or more ink layers.

5. The method of claim 1 wherein the base layer application step further comprises drying the substrate following application of the base layer.

6. The method of claim 1 wherein the graphical application step comprises applying at least one white ink layer to the substrate.

7. The method of claim 1 wherein the graphical application step comprises applying at least one colored ink layer to the substrate.

8. The method of claim 1 wherein the graphical application step comprises applying at least one white ink layer to the substrate, and subsequently applying at least one colored ink layer to the substrate.

9. The method of claim 1 wherein at least one ink layer is applied in a single process.

10. The method of claim 1 wherein at least one ink layer is applied using an inkjet and at least one ink layer is applied using a valve jet.

11. The method of claim 1 wherein the graphical application step further comprises drying the substrate following application of the one or more ink layers.

12. The method of claim 1 further comprising a topcoat application step, wherein the topcoat is applied to only a portion of the substrate.

13. The method of claim 12 wherein the topcoat is applied to substantially the same portion of the substrate as the one or more ink layers.

14. The method of claim 12 wherein the topcoat is applied using a valve jet or an inkjet printhead having a diameter of at least about 30 microns.

15. The method of claim 12 wherein the topcoat application step further comprises drying the substrate following application of the topcoat.

16. The method of claim 1 wherein the base layer application step comprises applying a pretreatment composition to the substrate.

17. The method of claim 16 wherein the pretreatment composition comprises:
a water-dispersing polymer resin component, in an amount of from about 5% by weight to about 30% by weight of the composition;
a coalescing solvent component, in an amount of from about 10% by weight to about 35% by weight of the composition; and
water, in an amount of from about 40% to about 90% by weight of the composition.

18. The method of claim 17 wherein the pretreatment composition further comprises one or more additives selected from the group consisting of defoamers, wetting agents, adhesion promoters, and softening agents,
and wherein the pretreatment composition comprises the one or more additives in an amount of from 0% to about 10% by weight by weight of the composition.

19. The method of claim 17 wherein the pretreatment composition does not comprise any plasticizers.

20. A printed textile prepared according to the method of claim 1.
